(19) United States
(12) Patent Application Publication
(10) Pub. No.: US 2024/0428054 A1
(43) Pub. Date: Dec. 26, 2024

(54) LINEAR MODEL VALIDATION

(71) Applicant: BASF SE, Ludwigshafen Am Rhein (DE)

(72) Inventors: Iain Proctor, Limburgerhof (DE); Eduard Szoecs, Ludwigshafen (DE); Georgios Kritikos, Ludwigshafen (DE); Till Eggers, Ludwigshafen (DE)

(21) Appl. No.: 18/684,043

(22) PCT Filed: Aug. 17, 2022
(86) PCT No.: PCT/EP2022/072949

§ 371 Date: Feb. 15, 2024

(30) Foreign Application Priority Data
Aug. 17, 2021 (EP) 21191785.1

(51) Int. Cl. G06N 3/0464

(52) U.S. Cl. CPC G06N 3/0464

(57) ABSTRACT

The present invention relates to validating a linear model. Input data is received (102) and the linear model to be validated is provided (104). Predicted data is determined based on processing input data by the linear model (106). Residual data is determined based on a difference between the predicted data and the input data (108). A set of validation data including homoscedasticity validation data or normality validation data is generated based on the residual data (110). A binary classifier is provided and used for determining whether the set of validation data fulfills a validation condition (112), namely a homoscedasticity condition or a normality condition. The binary classifier is a trained data driven model that outputs that the validation condition is fulfilled or not fulfilled depending on the set of validation data. Finally, it is determined whether the linear model is valid based on the output of the binary classifier (114).

### FIELD OF THE INVENTION

The present invention relates to a system for validating a linear model, a method for validating a linear model, and a computer program product for validating a linear model.

### BACKGROUND OF THE INVENTION

The article “Testing for normality with neural networks” by M. Simić published in Neural Comput & Applic (2021) (https://doi.org/10.1007/s00521-021-06229-7) discloses treating the problem of testing for normality as a binary classification problem and constructing a feedforward neural network (NN) that can act as a normality test. The NN can classify a distribution as normal or non-normal by inspecting a small sample drawn from it. A frequency of false non-normal predictions can be controlled by changing the decision threshold of the feedforward NN. This makes the network more similar to standard statistical tests. Hyperparameters considered are q, that determines the structure of so called descriptors, d, the network's depth, i.e., the number of hidden layers, w, the network's width, i.e., the number of neurons in a hidden layer, and c, the regularization coefficient. A descriptor represents a number of descriptive statistics of a sample, such as mean, median, standard deviation, etc. The descriptor is an array including the descriptive statistics. The highest accuracy was achieved based on the following configuration of parameters. The feedforward NN has a network's depth d of five hidden layers containing a network's width w of 100 neurons each, the parameter q is set to 0.05, and the network is trained with the regularization coefficient c set to 1. The final layer of the feedforward NN is designed to be the softmax layer such that the output of the feedforward NN is a probability value that a sample comes from a normal distribution. A respective sample is classified as coming from a normal distribution if the probability value is equal to or above the decision threshold and as coming from a non-normal distribution if the probability value is below the decision threshold.

### SUMMARY OF THE INVENTION

It can be seen as an object of the present invention to provide a system for validating a linear model, a method for validating a linear model, a computer program product for validating a linear model, and a computer-readable medium which allow an improved or at least alternative validation of a linear model.

In a first aspect of the present invention a system for validating a linear model is presented. The system comprises a communication interface and a processor. The communication interface is configured for receiving input data which includes response values for different explanatory values. The processor is configured for validating the linear model by performing the steps:
determining predicted data based on processing the input data by the linear model, wherein the predicted data includes predicted values for the different explanatory values,
determining residual data based on a difference between the predicted data and the input data, wherein the residual data includes residual values for the different explanatory values determined based on the difference between the response values and their corresponding predicted values,
generating a set of validation data based on the residual data, wherein the set of validation data includes homoscedasticity validation data or normality validation data,
providing a binary classifier for determining whether the set of validation data fulfills a validation condition, wherein the validation condition is a homoscedasticity condition if the set of validation data includes homoscedasticity validation data or a normality condition if the set of validation data includes normality validation data, and wherein the binary classifier is a data driven model trained based on training sets of training validation data fulfilling the validation condition and training sets of training validation data not fulfilling the validation condition, such that the binary classifier outputs that the validation condition is fulfilled or not fulfilled depending on the set of validation data which is provided as input to the binary classifier,
determining by the binary classifier whether the set of validation data fulfills the validation condition, and
determining whether the linear model is valid based on the output of the binary classifier.

Since the system validates the linear model based on a binary classifier, an improved or at least alternative validation of the linear model is presented. The system may allow the use of automatically validated assumptions or requisites, respectively, of the linear model. Moreover, the system may allow for the use of objected validated assumptions or requisites, respectively, leading to an objectification of the validation of the linear model. The system may allow for a correct automatic application of linear models. Since the binary classifier determines whether a homoscedasticity validation condition or a normality validation condition is fulfilled, the linear model may be validated based on the most important validation conditions or assumptions, respectively, for the residual data obtained based on the linear model.

The invention is based on the understanding that linear models are used for predicting values for various processes, e.g., in chemical industry. Validating a linear model, i.e., determining whether the linear model correctly reflects the observed behavior, is an outstanding problem in statistics. Linear models may be validated by using statistical tests on residuals of the measured data or by human expert visual inspection of residual plots. A linear model may be validated based on determining whether the linear model violates given assumptions of linear models, such as normality and homoscedasticity of the residuals and linearity of the explanatory and response variables. The publications of Nornadiah Mohd Razali and Yap Bee Wah, “Power comparisons of Shapiro-Wilk, Kolmogorov-Smirnov, Lilliefors and Anderson-Darling tests” published in J. Stat. Model. Analytics. Vol. 2, No. 1, 21-33, 2011, and Tjen-Sien Lim, Wei-Yin Loh, “A comparison of tests of equality of variances” published in Computational Statistics & Data Analysis, Volume 22, Issue 3, 287-301, 1996, indicate that linear models validated by statistical tests known in the prior art do not always perform satisfactorily. It can be shown empirically that statistical tests known in the prior art can be inadequate. Linear models validated by visual inspection of human experts require an experienced and well-trained human expert for interpretation of residual plots which may also have a subjective bias in her or his validation of the linear models. The system allows these disadvantages to be overcome. For example, no residual plots need to be generated since the binary classifier may determine whether the set of validation data fulfills the validation condition. Moreover, using a binary classifier allows for an objective and accurate validation of the linear model avoiding the use of statistically inaccurate methods or depending on the knowledge of human experts. Furthermore, utilizing the binary classifier allows to avoid using fixed rules or thresholds for all cases when automating the validation process to allow for a higher objectivity. Such rules and threshold algorithms have the strong disadvantage that they are only accurate for a very limited number of cases and not flexible enough to also deal with cases outside the predetermined very limited application range. Thus, the invention allows to improve the reliability of a validated linear model and therefore to increase an application security of the linear model in an application context.

Improving the reliability of a linear model by providing a more reliable and objective validation possibility for the linear model is an important task for many relevant applications. For example, in a modern agricultural context linear models are often utilized for predicting the necessary amounts of additive substances like plant protectants and fertilizers. If a linear model in this context is not validated accurately and, for example, if an expert validating the linear model makes human mistakes, the consequences can lead directly to plant and environmental damage, if for instance, a far too high amount of protectant or fertilizer is predicted by the linear model. Generally this scenario can in most cases be avoided by implementing respective security thresholds, but also only slight inaccuracies in the predicted amount of, for instance, protectants can have unwanted consequences, in particular, the building of resistances with respect to specific protectants. Moreover, linear models are also often utilized in quality control scenarios, in which the quality of produced products is evaluated based on measurements performed during the production of the product that are indicative of the quality of the produced product. Also in this case it is important that the linear model is validated accurately and objectively to avoid the delivering of qualitatively low or even non-functional products. Moreover, a linear model allows in most cases to directly determine if a production process leads to the production of a product that does not meet the production goal such that the production process can be changed directly to avoid the production of such unwanted products. For example, process parameters can be amended and controlled based on such linear models very fast to ensure the production quality, if the linear model is accurately and objectively validated.

The input data is preferably provided by sensors and thus refers to measured data including the response values. Preferably, the linear model is applied in a quality control context or in a product development context. Moreover, in another preferred application context the linear model is utilized in an agricultural context. The input data measured by sensors can thus depend on a specific context. For example, in an agricultural application the input data may be, for example, measured data including response values in form of measured values, such as measured plant yield values, or biomass values, or grain yield values, respectively, for different explanatory values, such as different fields. The different fields may be treated differently, e.g., different genetically modified plants may be grown on the different fields or a different product may be applied to the fields, such as different types of chemicals such as herbicides, different quantity or different concentrations of chemicals and/or the chemicals may be applied, such as sprayed, in different patterns on the fields. The input data may also include any other type of response variable with corresponding response values for different explanatory values. For example, in an application referring to drug development, the response variables can be related to drug efficacy or toxicology. In an example, related to quality control the response values can refer to different qualities or properties of the produced product related to respective process parameters of the production process of the respective product as explanatory values. The predicted data then generally refers to predictions of the response values based on the explanatory values for the respective application. For example, the predicted data can includes predicted plant yield values of the different fields predicted by the linear model. The residual data includes residual values determined based on, e.g., the difference between the predicted values and their corresponding measured values, i.e., the difference between predicted values and measured values for identical explanatory values.

The set of validation data may, for example, be formed by a data frame including two columns. One of the two columns may, for example, include the predicted values and the other of the two columns may include the residual values. A number of rows of the data frame may be based to a number of the response values in the input data. The number of rows of the data frame may, for example, be identical to the number of the response values in the input data.

The homoscedasticity validation data may include the residual values associated to their respective predicted values. Alternatively, the homoscedasticity validation data may include residual values associated to another variable, e.g., their respective explanatory values, or an index of the residual values. The index of the residual values may, for example, associate a certain number to each of the residual values. This may allow the determination of whether the linear model leads to residual values with similar or equal variances across the explanatory values, i.e., whether the residual values are homoscedastic.

The normality validation data may include counts associated to different ranges of the residual values. The residual values may, for example, be arranged in a number of bins each for a predetermined range or percentile of the residual values and a count of residual values in the bin may be determined for each of the bins. This may allow the determination of whether the residual values determined based on the linear model are normally distributed.

The processor may be configured for determining the predicted data by using the different explanatory values of the input data as input to the linear model and calculating the predicted values for the different explanatory values by the linear model.

The processor may be configured for determining the residual data, for example, by determining a difference between the predicted values and their corresponding response values. The linear model may be, for example, a linear regression model.

The processor may be further configured for providing the linear model. This allows providing the linear model for further processing, e.g., in order to use the linear model, such as for processing further input data. The processor may be configured for providing the linear model if the linear model is determined to be valid. In other words, the linear model may be deployed. Additionally, or alternatively, the linear model and/or its validation result, i.e., whether the linear model is valid or not, may be displayed, e.g., via a user interface.

The processor may be further configured for adapting the linear model to an adapted linear model. Furthermore, the processor may be configured for performing the steps performed for validating the linear model on the adapted linear model. The processor may be configured for adapting the linear model to the adapted linear model, for example, if the linear model is determined not to be valid. This allows an iterative adaption of the linear model until the linear model is valid.

The adapted linear model may include, for example, adapted values of its parameters. The processor may be configured for optimizing one or more parameters of the linear model, e.g., iteratively, until a fit of the predicted data with the input data is optimized, e.g., until a mean squared residual is minimized. After the processor adapted the linear model to the adapted linear model, the system may be configured for validating the adapted linear model.

The processor may be configured for adapting the linear model based on transforming the input data, e.g., the response variable. Transforming the input data allows transforming the linear model. For example, the parameters of the linear model depend on the input data to which the linear model is fitted. The adapted linear model may have different values for the parameters.

Transforming the input data results in adapted input data, e.g., by applying a function on the input data, such as a natural log-function, square root-function, logit-function, or any other strictly monotonic function. The strictly monotonic function may be increasing or decreasing. The processor may be configured for adapting the one or more parameters of the adapted linear model based on the transformed input data. The processor may be configured for determining the predicted data based on the adapted input data and the adapted linear model. The processor may also be configured for determining the residual data based on a difference between the predicted data and the adapted input data. This allows optimizing a fit of the adapted linear model to the adapted input data and may allow a valid adapted linear model to be obtained.

The processor may be further configured for iteratively adapting the linear model until the adapted linear model is determined to be valid. This allows a valid linear model based on an initial linear model to be found automatically.

The response values may be measured plant yield values. The different explanatory values may relate to different fields on which the plants grow. For example, the different explanatory values may be different fields on which the plants grow, different genetically modified plants grown in the different fields, different products applied to plants on the different fields, such as different concentrations of agricultural chemicals applied on the different fields. Studying the measured plant yield values may allow determining a susceptibility of the plants on the different fields to diseases, e.g., in case of genetically modified plants grown in the different fields, or determining an effect of different products applied to the plants on the different fields, e.g., applying different types of herbicides, applying different quantities of herbicides, applying different concentrations of herbicides, and/or applying the herbicides in different distribution patterns to the plants in the different fields. The measured plant yield values may, for example, be measured for plants, such as soy plants, or any other crop plants. The measured plant yield values may correspond to plant yields of plants with a certain minimum quality.

The system may be configured for controlling a growth of the plants in the different fields based on the linear model. Additionally, the system may be configured for controlling the growth of the plants in the different fields based on the linear model if the linear model is determined to be valid. The system may be configured for controlling the growth of the plants, for example, by planting new genetically modified plants with an increased plant yield or by applying a product on the plants of the different fields, e.g., applying a certain type of herbicide, applying a certain quantity of herbicide, applying a certain concentration of herbicide, and/or applying the product in a certain distribution pattern, in order to increase the plant yield. This may allow an automatic increase in plant yields. The system may include, for example, a drone or automatic robotic system which controls growth of the plants, e.g., by planting seeds of genetically modified plants or applying the product to the plants on the fields, e.g., spraying it on the fields. The system may also include an automated greenhouse or it may be integrated in an automated greenhouse. A drone or automatic robotic system of the automated greenhouse may be controlled based on the linear model.

The system may be configured for optimizing the plant yield values based on the linear model. This may allow the provision of a system for automatically validating a linear model and using the linear model for optimizing the plant yield values. For example, the plant yield values may be increased by growing new plants in the different fields based on the validated linear model. An optimal genetically modified plant or combination of plants may be grown in the different fields, or different products may be applied to the plants with optimal type, in optimal quantity, in optimal concentration, and/or in optimal distribution patterns to the plants on the different fields.

The linear model may be, for example, an agricultural chemical effectiveness verification model for verifying effectiveness of agricultural chemicals. The input data may be, for example, plant screening data. The plant screening data may include, for example, plant yield values for different fields. This may allow the verification of the effectiveness of agricultural chemicals to be improved.

In another application, the response values can be quality or property measurement values for a produced product. The different explanatory values can then relate to different process parameters used for producing the respective products and/or quality measurements performed for determining a quality or property of the product. For example, the different explanatory values being process parameters can related to temperature profiles, pressure profiles, mixing speeds, mass flows, catalysts, etc. that are used in a production process for producing a chemical product. The system can then be configured for controlling a production of a product, in particular, by controlling the process parameter of the production process, based on the linear model. For example, the linear model can be utilized for prediction of a quality or property of a product based on measured or otherwise known process parameters. Based on the prediction process parameters can then be amended until the prediction meets a predetermined goal, for example, a predetermined product quality or property. Thus, the system can be configured for optimizing the production process with respect to one or more aspects, for instance, quality or a product property. This may allow the provision of a system for automatically validating a linear model and using the linear model for optimizing a production process. For example, a quality of a product can be increased based on the prediction of the linear model. In another example, the different explanatory values being quality measures can related to optical measurements, in particular, images, of a product, x-ray-measurements, surface profiles, stress measurements, etc. that are performed on the final product or on any pre-stage of the product on the way to a final product and that are indicative of a quality of the product or its properties. To determine from these measures a quality or property of the product a linear model can then be utilized. If it is determine that a quality or property is not according to a predetermined standard, measures can be taken to avoid that the faulty product is further processed. For example, if a plurality of products are provided on a conveyor belt, optical imaging and processing using a linear model can be utilized to determine faulty products on the conveyor belt in a fast and automated manner. When determining a faulty product on the conveyor belt the faulty product an automatically be removed by respective removal means depending on the product utilizing, for example, air blowers, magnets, grippers, lasers, etc.

The processor may be configured for generating at least two different sets of validation data based on the residual data. Additionally, the processor may be configured for providing at least two binary classifiers each configured for determining whether the respective set of validation data fulfills a respective validation condition. Furthermore, the processor may be configured for determining whether the linear model is valid based on the output of the at least two binary classifiers. This allows different validation conditions for validating the linear model to be considered. For example, a homoscedasticity binary classifier may be configured for determining whether a first set of validation data including homoscedasticity validation data fulfills the homoscedasticity condition and a normality binary classifier may be configured for determining whether a second set of validation data including normality validation data fulfills the normality condition. This allows validation of the linear model to be improved. The processor may be configured for generating the at least two different sets of validation data such that one of the sets of validation data includes homoscedasticity validation data and one of the sets of validation data includes normality validation data. This allows validation of the linear model to be improved further. The linear model may be valid, for example, if at least one or at least two of the at least two binary classifiers output that the respective validation condition is fulfilled. Since a combination of validation conditions may have to be fulfilled by the linear model, reliability in the determination of the validity of the linear model may be improved.

The binary classifier may be a trained convolutional neural network (CNN). This may allow validation accuracy to be improved. A CNN is a NN which includes at least one convolutional layer, i.e., a layer of neurons which are only connected to the output of neurons of their local receptive field in the previous layer. The CNN may have an output layer in form of a fully connected layer or a densely connected layer with a sigmoid activation function.

The homoscedasticity binary classifier may be trained based on training sets of training homoscedasticity validation data, e.g., each in form of a data frame including two columns, e.g., a 2D vector, one with predicted values and one with corresponding residual values. Each of the 2D vectors may include, for example, 50 to 200 observations. In order to have a same size, zeros may be added for 2D vectors with smaller than 200 observations. The output provided by the homoscedasticity binary classifier is a single value, e.g., yes or no, or 1 or 0, respectively, indicating whether the linear model fulfills the homoscedasticity validation condition. The training may be performed, for example, in 10 to 30, such as 20 epochs using a learning rate of 0.003. The training may be performed based on mini-batch gradient descent, e.g., RMSprop, with a mini-batch size of 512. Permutation parameters of the training sets of training homoscedasticity validation data used for training the homoscedasticity binary classifier may include one or more of, for example, a number of observations, a slope rate, and a shape. The shape of homoscedasticity training plots of which one can be generated based on each of the training sets of training homoscedasticity validation data may include, for example, convex, concave, increasing, decreasing, and random. Preferably, as many random training sets of training homoscedasticity validation data as for all other shapes combined may be provided. For example, an order of 38400 training sets of training homoscedasticity validation data may be provided for training the homoscedasticity binary classifier. Each of the training sets of training homoscedasticity validation data may be generated by simulating one of the following shapes, random, increasing variance, decreasing variance, convex shape, concave shape. The random shape indicates homoscedasticity, while the others indicate heteroscedasticity. The training sets may be labeled accordingly, e.g., include a corresponding class information. The convex shape corresponds to an increasing and then decreasing variance. The concave shape corresponds to a decreasing and then increasing variance. Each of the training sets of training homoscedasticity validation data which indicates heteroscedasticity may be generated by sampling a range of parameters, such as variance, rate, and mid point. The variance may be sampled to remain stable, increase or decrease according to the shape. The rate corresponds to a steepness of variance change. The midpoint corresponds to a reversal of variance change for concave and convex shapes. The training sets of training homoscedasticity validation data were balanced in that equally as many indicate homoscedasticity, i.e., 19200 random shaped, as heteroscedasticity, i.e., 4800 per each shape. Subsequently randomly 80% of the trainings sets were assigned for training and 20% were assigned as testing sets.

The normality binary classifier may be trained based on training sets of training normality validation data, e.g., each in form of one dimensional residual values vectors. Each of the 1D vectors may include, for example, 50 to 200 observations. In order to have a same size, zeros may be added for 1D vectors with smaller than 200 observations. The output provided by the normality binary classifier is a single value, e.g., yes or no, or 1 or 0, respectively, indicating whether the linear model fulfills the normality validation condition. The training may be performed, for example, in 10 to 30, such as 20 epochs using a learning rate of 0.001. The training may be performed based on mini-batch gradient descent, e.g., RMSprop, with a mini-batch size of 512. Permutation parameters of the training sets of training normality validation data used for training the normality binary classifier may include one or more of, for example, a number of observations, a shape of the distribution, Poisson lambda, skew alpha, and log-normal standard deviation. The shape of the distribution may include, for example, a normal shape, a Poisson shape, a log-normal shape, and a skew-normal shape. For example, 1250 training sets of training normality validation data may be provided per parameter combination, e.g., resulting in about 270000 training sets of training normality validation data for training the normality binary classifier. Each of the training sets may be generated by sampling one of normal distribution, skew-normal distribution, Poisson distribution, log-normal distribution. The normal distribution indicates normality, while the others indicate that the distribution is not normal. The training sets may be labeled accordingly, e.g., include a corresponding class information. The training sets of training normality validation data were balanced in that equally as many indicate normality, i.e., 135000 normal distributions, as non-normality. Subsequently randomly 80% of the trainings sets were assigned for training and 20% were assigned as testing sets.

Training data in form of training sets of training validation data may be provided in form of simulated data with known properties. The simulated data may be artificially generated based on known functions, e.g., a linear function and adding random deviations from the linear function. This allows the binary classifier to be trained without a need of real-world data.

The CNN may have at least 4 convolutional layers, e.g., the CNN may have 4 convolutional layers. The homoscedasticity binary classifier may be, for example, a CNN formed by a 2D convolution with 4 convolutional layers. The normality binary classifier may be, for example a CNN with 4 convolutional layers.

The CNN may have the following architecture:
a first convolutional layer,
a first max pooling layer,
a second convolutional layer,
a third convolutional layer,
a second max pooling layer,
a dropout layer,
a fourth convolutional layer,
a global max pooling layer,
a first densely-connected layer, and
a second densely-connected layer. Additionally, the CNN may include an input layer and/or an output layer.

The CNN may be a 2D CNN for determining whether the set of validation data fulfills the homoscedasticity validation condition. The 2D CNN may be trained based on training sets of training homoscedasticity validation data, e.g., each in form of a data frame including two columns, e.g., a 2D vector, one with predicted values and one with corresponding residual values. The 2D CNN may have an input size of 200. The activation functions of all but the output layer may be rectified linear unit (ReLU) activation functions. The output layer may have a sigmoid activation function and an output size of 1. The first convolutional layer of the 2D CNN may have an output size of 32 and a kernel size of 5×1. The max pooling layers may have a pool size of 5×1. The second and third convolutional layer may have an output size of 64 and a kemel size of 5×1. The fourth convolutional layer may have an output size of 128 and a kernel size of 5×1. The dropout layer may have a dropout rate of 0.2. The first densely-connected layer may have an output size of 64, the second densely-connected layer may have an output size of 2 and the output layer may output a single value, i.e., 0 or 1, corresponding to yes or no.

The CNN may be a 1D CNN for determining whether the set of validation data fulfills the normality validation condition. The 1D CNN may be trained based on training sets of training normality validation data, e.g., each in form of one dimensional residual values vectors. The 1D CNN may have an input size of 200. The activation functions of all but the output layer may be ReLU activation functions. The output layer may have a sigmoid activation function and an output size of 1. The first convolutional layer of the 1D CNN may have an output size of 32 and a kernel size of 4. The max pooling layers may have a pool size of 4. The second and third convolutional layer may have an output size of 64 and a kernel size of 4. The fourth convolutional layer may have an output size of 128 and a kernel size of 4. The dropout layer may have a dropout rate of 0.2. The first densely-connected layer may have an output size of 64, the second densely-connected layer may have an output size of 2, and the output layer may output a single value, i.e., 0 or 1, corresponding to yes or no.

The processor may be configured for validating the linear model by additionally performing the steps:
providing a linearity binary classifier for determining whether the input data fulfills a linearity condition, wherein the linearity binary classifier is a data driven model trained based on training sets of training input data fulfilling the linearity condition and training sets of training input data not fulfilling the linearity condition, such that the linearity binary classifier outputs that the linearity condition is fulfilled or not fulfilled depending on the input data which is provided as input to the linearity binary classifier,
determining by the linearity binary classifier whether the input data fulfills the linearity condition, and
determining whether the linear model is valid additionally based on the output of the linearity binary classifier. This allows to determine whether there is a linear relationship between explanatory and response variables included in the input data. In other words, this may allow to determine whether a mean of the response values at the corresponding explanatory values is a linear function of the explanatory variable.

The system may include one or more application programmatic interfaces (APIs) to which input data may be provided from one or more different data sources. This allows validating linear models of different kinds, e.g., on-the-fly, for example, during statistical analysis of plant screening data.

The system may furthermore be configured for performing other applications based on the linear model, if the linear model is determined to be valid. Other applications may include, for example controlling drug administration based on drug efficacy and/or toxicology. Further applications may include controlled breeding, controlled protection of crops, as well as other applications in the nutrition and/or health sector.

In a further aspect a computer-implemented method for validating a linear model is presented. The method comprises the steps:
receiving input data which includes response values for different explanatory values, and
validating the linear model by performing the steps:
   determining predicted data based on processing the input data by the linear model, wherein the predicted data includes predicted values for the different explanatory values,
   determining residual data based on a difference between the predicted data and the input data, wherein the residual data includes residual values for the different explanatory values determined based on the difference between the response values and their corresponding predicted values,
   generating a set of validation data based on the residual data, wherein the set of validation data includes homoscedasticity validation data or normality validation data,
   providing a binary classifier for determining whether the set of validation data fulfills a validation condition, wherein the validation condition is a homoscedasticity condition if the set of validation data includes homoscedasticity validation data or a normality condition if the set of validation data includes normality validation data, and wherein the binary classifier is a data driven model trained based on training sets of training validation data fulfilling the validation condition and training sets of training validation data not fulfilling the validation condition, such that the binary classifier outputs that the validation condition is fulfilled or not fulfilled depending on the set of validation data which is provided as input to the binary classifier,
   determining by the binary classifier whether the set of validation data fulfils the validation condition, and
   determining whether the linear model is valid based on the output of the binary classifier.

The computer-implemented method may include one or more of the steps:
providing the linear model, if the linear model is determined to be valid,
adapting the linear model to an adapted linear model,
performing the steps performed for validating the linear model on the adapted linear model,
adapting the linear model based on transforming the input data,
iteratively adapting the linear model until the adapted linear model is determined to be valid,
measuring plant yield values as response values related to different fields on which the plants grow as explanatory values,
controlling growth of the plants in the different fields based on the linear model, if the linear model is determined to be valid,
generating at least two different sets of validation data based on the residual data,
providing at least two binary classifiers each configured for determining whether the respective set of validation data fulfills a respective validation condition,
determining whether the linear model is valid based on the output of the at least two binary classifiers,
providing the binary classifier as a CNN,
providing that the CNN has at least 4 convolutional layers, e.g., 4 convolutional layers,
providing that the CNN has the following architectures:
   a first convolutional layer,
   a first max pooling layer,
   a second convolutional layer,
   a third convolutional layer,
   a second max pooling layer,
   a dropout layer,
   a fourth convolutional layer,
   a global max pooling layer,
   a first densely-connected layer, and
   a second densely-connected layer, and
training the binary classifier based on training sets of training validation data fulfilling the validation condition and training sets of training validation data not fulfilling the validation condition, such that the binary classifier outputs that the validation condition is fulfilled or not fulfilled depending on the set of validation data which is provided as input to the binary classifier.

Additionally, or alternatively, the method may include the additional steps for validating the linear model:
providing a linearity binary classifier for determining whether the input data fulfills a linearity condition, wherein the linearity binary classifier is a data driven model trained based on training sets of training input data fulfilling the linearity condition and training sets of training input data not fulfilling the linearity condition, such that the linearity binary classifier outputs that the linearity condition is fulfilled or not fulfilled depending on the input data which is provided as input to the linearity binary classifier,
determining by the linearity binary classifier whether the input data fulfills the linearity condition, and
determining whether the linear model is valid additionally based on the output of the linearity binary classifier.

Additionally, or alternatively, the method may include one or more of the steps:
determining predicted data based on the adapted input data and the adapted linear model, and
determining residual data based on a difference between the predicted data and the adapted input data.

In a further aspect a computer program product for validating a linear model is presented. The computer program product comprises program code means for causing a processor to carry out the computer-implemented method according to claim 12 or 13, or any embodiment of the method, when the computer program product is run on the processor.

In another aspect a computer-readable medium having stored the computer program product according to claim 14 or any embodiment of the computer program product is presented.

It shall be understood that the system of claim 1, the computer-implemented method of claim 12, the computer program product of claim 14, and the computer-readable medium of claim 15 have similar and/or identical preferred embodiments, in particular, as defined in the dependent claims.

It shall be understood that a preferred embodiment of the present invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows a flow diagram of an embodiment of a method for validating a linear model,

FIG. 2 shows schematically and exemplarily a system for validating a linear model,

FIG. 3 shows exemplarily a linear model fitted to input data,

FIG. 4 shows exemplarily different graphs indicating homoscedasticity, linearity, and normality,

FIG. 5 shows an architecture of a 2D CNN for checking homoscedasticity,

FIG. 6 shows an architecture of a 1D CNN for checking normality,

FIG. 7 shows an embodiment of a training method for training the 2D CNN for checking homoscedasticity,

FIG. 8 shows an embodiment of a training method for training the 1D CNN for checking normality,

FIG. 9 shows a comparison of validation accuracy of the 1D CNN for checking for normality compared to prior art statistical methods for checking for normality, and

FIGS. 10, 11 show exemplary applications of the method for validating a linear model.

### DETAILED DESCRIPTION OF EMBODIMENTS

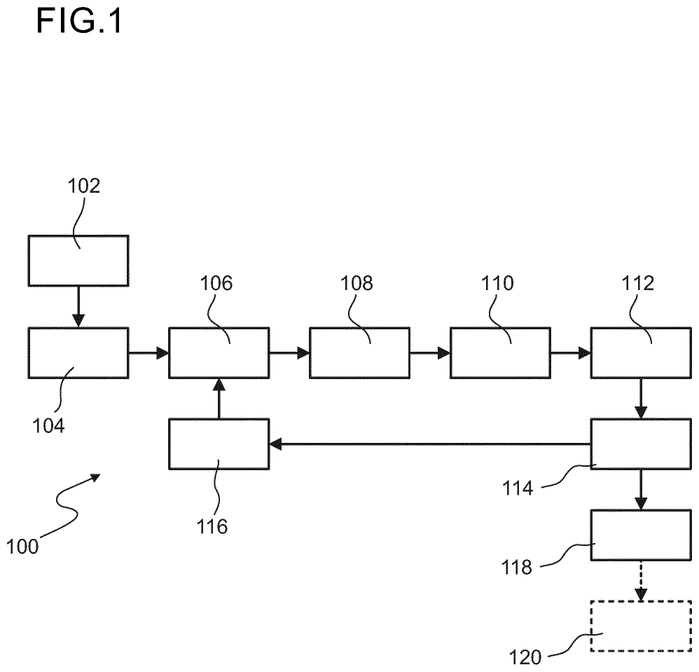

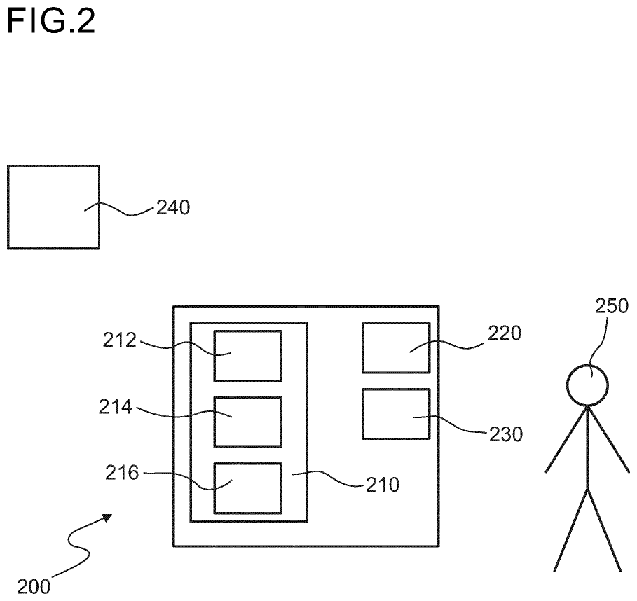

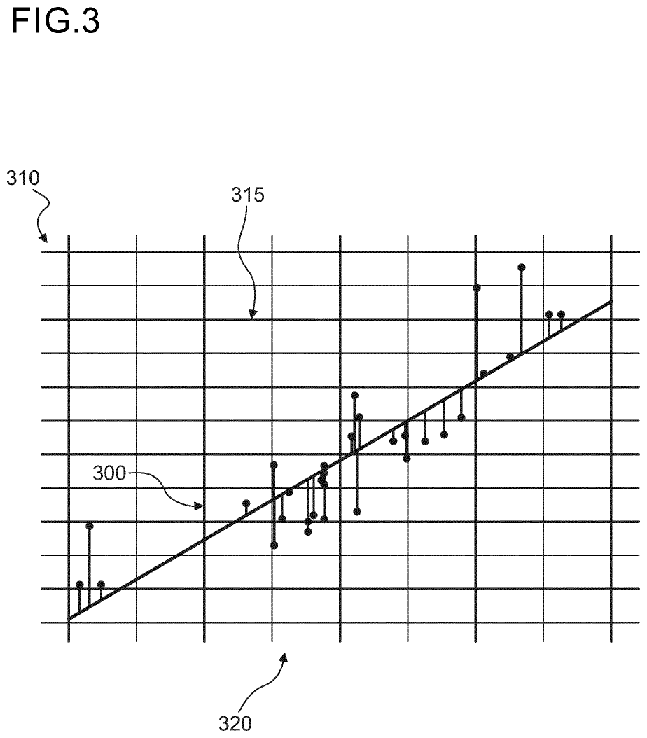

FIG. 1 shows a flow diagram of an embodiment of a computer-implemented method 100 for validating a linear model, such as linear model 300 presented in FIG. 3. The method 100 may be performed, for example, on a system 200 as presented in FIG. 2 for validating the linear model 300. The system 200 includes a communication interface 210, a processor 220, and a computer-readable medium in form of memory 230.

The communication interface 210 is configured for exchanging data, e.g., with a server or a user. The processor 210 is configured for processing data, e.g., input data. The memory 230 stores data, algorithms, linear models, as well as data driven models, in particular CNNs for validating the linear model 300. Furthermore, the memory 230 may store a computer program product for validating the linear model 300. The computer program product may comprise program code means for causing the processor 220 to carry out the computer-implemented method 100 when the computer program product is run on the processor 220.

FIG. 3 exemplarily shows the linear model 300 fitted to input data 315 including response values 310 and explanatory values 320. The linear model 300 is used for determining predicted values 330 and residual values 340 in form of differences between the response values 310 and the predicted values 330. In this embodiment, the vertical axis shows an activity of a target, e.g., a fungus, weed, or an insect, in percent and the horizontal axis shows an effective concentration of an agricultural chemical, e.g., a herbicide, a fungicide, or an insecticide in mol/l, e.g., between 10⁻¹⁰ to 10⁻⁵ mol/l. In this embodiment, a log-logistic model is applied in order to determine an effective concentration of the agricultural chemical for reducing the activity of the target by 50% (EC50).

The linear model 300 may, for example, be used for determining an optimal quantity or optimal concentration of the agricultural chemical to be applied to a field on which plants are grown for maximizing plant yield values. Applying an agricultural chemical, e.g., a herbicide to a field which grows plants may reduce growth of undesired plants stronger than of desired plants. The herbicide may, however, also affect the desired plants, e.g., diminishing their growth. This may allow optimizing plant yield values in dependence of an applied quantity of the agricultural chemical. In other embodiments, other linear models may be used.

In the following the steps performed by the computer-implemented method 100 are described. In this embodiment, the steps are performed on system 200 presented in FIG. 2. In other embodiments, the steps may also be performed on another system.

In step 102, input data 315 is received which includes response values 310 for different explanatory values 320. The input data 315 is received by the communication interface 210 which is configured for receiving it. The communication interface 210 includes a transceiver 212 and an antenna array 214 for exchanging data with a server 240 which includes the input data 315. In this embodiment, the input data 315 is plant screening data with response values 310 in form of measured plant yield values and explanatory values 320 in form of different concentrations of the herbicide. The different concentrations are applied to different fields, such that effectively plant yield values for different fields may be compared for which all other conditions are kept constant while only varying concentrations of the herbicide. The plant screening data may be obtained, for example, via drones flying over the different fields and obtaining images of the plants on the fields from above. The images may be processed based on image processing algorithms for determining a plant yield value for each of the different fields. In other embodiments, other methods for obtaining response values for the different explanatory values may be used.

In step 104, the linear model 300 is provided. The linear model is provided based on a stored linear model or a number of stored linear models without user interaction, e.g., based on the input data, for example, by applying one or more rules on the input data. The linear model 300 may depend on the application or use case. In other embodiments, the linear model 300 may be provided by a user 250. The communication interface 210 may include a user interface in form of a touch display 216 for receiving input. The input may be, for example, a selection of one of the stored linear models as linear model 300 or the linear model 300 may be provided directly by the user 250. Alternatively, the user may also provide the application or use case and the linear model 300 may be provided based on the application or use case.

The processor 220 is configured for validating the linear model 300. It performs steps 106 to 114 which are described in the following for validating the linear model 300.

In step 106, the input data 315 is used as input to the linear model 300 which is used to process the input data 315 in order to determine predicted data 325. The different explanatory values 320 are inserted in the linear model 300 which is used to calculate respective predicted values 330 for the different explanatory values 320, such that the predicted data 325 includes the predicted values 330 for the different explanatory values 320.

In step 108, residual data 335 is determined based on a difference between the predicted data 325 and the input data 315. The residual data 335 includes residual values 340 for the different explanatory values 320 determined based on the difference between the response values 310 and their corresponding predicted values 330. In other words, the difference between the response value 310 and the predicted value 330 for a certain explanatory value 320 is calculated in order to determine a residual value 340 for the certain explanatory value 320. This is performed for all different explanatory values 320 for determining the residual data 335.

In step 110, two sets of validation data are generated based on the residual data. In this embodiment, a first set of validation data includes homoscedasticity validation data and a second set of validation data includes normality validation data. The homoscedasticity validation data includes residual values associated to their respective predicted values arranged in a 2D vector, i.e., residual values are associated to predicted values for the same explanatory values. The normality validation data includes counts of residual values in different residual value ranges arranged in a 1D vector, i.e., a count of residual values falling into a residual value range is determined and stored in a 1D vector with counts in which each of the elements of the 1D vectors is associated to a predetermined residual value range. In other embodiments, also only one set of validation data may be generated based on the residual data. The set of validation data may include homoscedasticity validation data or normality validation data.

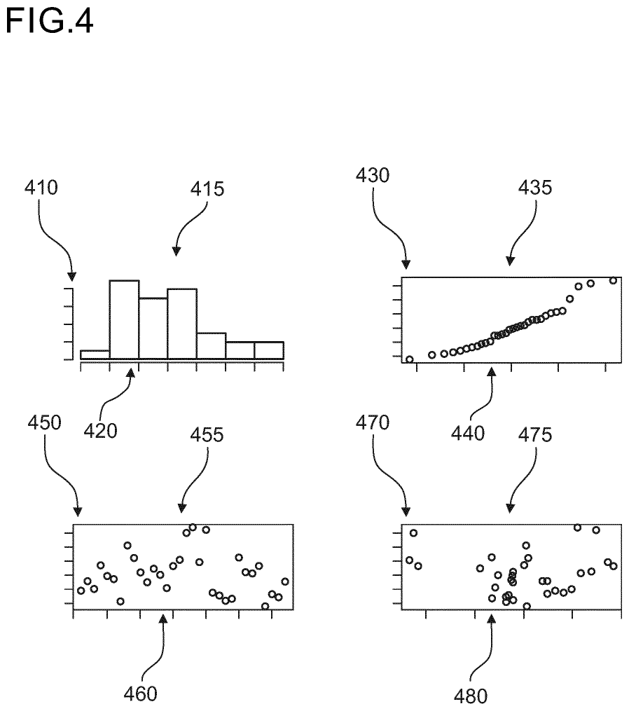

In FIG. 4, sets of validation data are, exemplarily, shown. Normality validation data 415 is presented at the top left with counts 410 of residual values plotted against the different residual value ranges 420. Normality validation data 435 in form of a quantile-quantile (Q-Q)-plot with sample quantile 430 and theoretical quantile 440 is presented at the top right. Furthermore, homoscedasticity validation data 455 is presented at the bottom left with residual values 450 plotted over an index 460. Finally, homoscedasticity validation data 475 is presented at the bottom right with residual values 470 plotted over the predicted values 480.

In step 112, two binary classifiers are provided, namely a homoscedasticity binary classifier for determining whether the first set of validation data fulfills a homoscedasticity validation condition and a normality binary classifier for determining whether the second set of validation data fulfills a normality validation condition. The homoscedasticity validation condition is fulfilled if the first set of validation data is homoscedastic, i.e., if the residual values are randomly distributed. The normality validation condition is fulfilled if the second set of validation data has a normal distribution.

In other embodiments, also only one binary classifier may be provided for determining whether the set of validation data fulfills a validation condition. The validation condition may be the homoscedasticity condition if the set of validation data includes homoscedasticity validation data or the normality condition if the set of validation data includes normality validation data. Furthermore, linearity of the input data may be checked additionally.

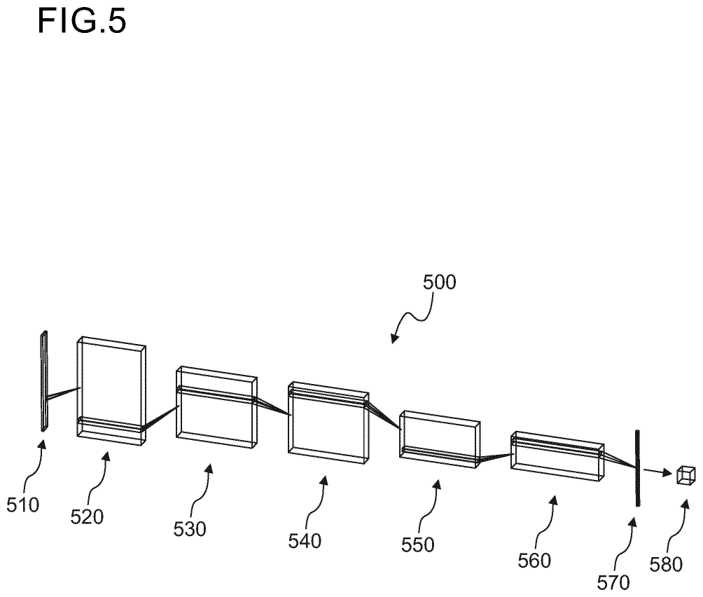

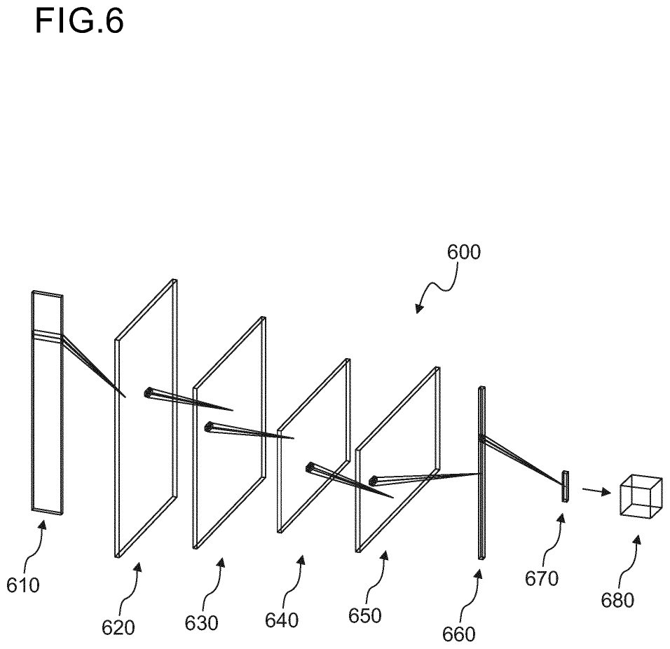

The binary classifiers are provided as data driven models in form of CNNs. The architecture of the homoscedasticity binary classifier 500 is schematically presented in FIG. 5 and the architecture of the normality binary classifier 600 is schematically presented in FIG. 6.

The homoscedasticity binary classifier 500 is built as a Keras sequential model with an input size of 200 observations in the 2D vector and has the following architecture:

| | | | | filter | filter | |
|---|---|---|---|---|---|---|
| layer type | height | width | depth | height | width | Rate |
| input layer 510 | 200 | 2 | 1 | 5 | 1 | — |
| convolutional layer 512 | 196 | 2 | 32 | 5 | 1 | — |
| max pooling layer 514 | 49 | 2 | 32 | 5 | 1 | — |
| convolutional layer 516 | 45 | 2 | 64 | 5 | 1 | — |
| convolutional layer 518 | 41 | 2 | 64 | 5 | 1 | — |
| max pooling layer 520 | 10 | 2 | 64 | 5 | 1 | — |
| dropout layer 522 | 10 | 2 | 64 | 5 | 1 | 0.2 |
| convolutional layer 524 | 6 | 2 | 128 | 5 | 1 | — |
| global max pooling layer | 128 | 1 | 1 | 1 | 1 | — |
| 526 | | | | | | |
| densely connected layer | 64 | 1 | 1 | 1 | 1 | — |
| 528 | | | | | | |
| densely-connected layer | 2 | 1 | 1 | 1 | 1 | — |
| 530 | | | | | | |
| output layer 532 | 1 | 1 | 1 | 1 | 1 | — |

The output of the homoscedasticity binary classifier 500 is a single value, e.g., 1 corresponding to yes or 0, corresponding to no.

The normality binary classifier 600 is built as a Keras sequential model with an input size of 200 observations in the 1D residual vector and has the following architecture:

| | | | | filter | filter | |
|---|---|---|---|---|---|---|
| layer type | height | width | depth | height | width | Rate |
| input layer 610 | 200 | 1 | 1 | 4 | 1 | — |
| convolutional layer 612 | 200 | 1 | 32 | 4 | 1 | — |
| max pooling layer 614 | 50 | 1 | 32 | 4 | 1 | — |
| convolutional layer 616 | 50 | 1 | 64 | 4 | 1 | — |
| convolutional layer 618 | 50 | 1 | 64 | 4 | 1 | — |
| max pooling layer 620 | 12 | 1 | 64 | 4 | 1 | — |
| dropout layer 622 | 12 | 1 | 64 | 4 | 1 | 0.2 |
| convolutional layer 624 | 12 | 1 | 128 | 4 | 1 | — |
| global max pooling layer | 128 | 1 | 1 | 4 | 1 | — |
| 626 | | | | | | |
| densely connected layer | 64 | 1 | 1 | 4 | 1 | — |
| 628 | | | | | | |
| densely-connected layer | 2 | 1 | 1 | 1 | 1 | — |
| 630 | | | | | | |
| output layer 632 | 1 | 1 | 1 | 1 | 1 | — |

The output of the normality binary classifier 600 is a single value, e.g., 1 corresponding to yes or 0, corresponding to no.

In other embodiments, the CNNs may also be provided with another architecture, preferably having at least 4 convolutional layers, e.g., 4 convolutional layers.

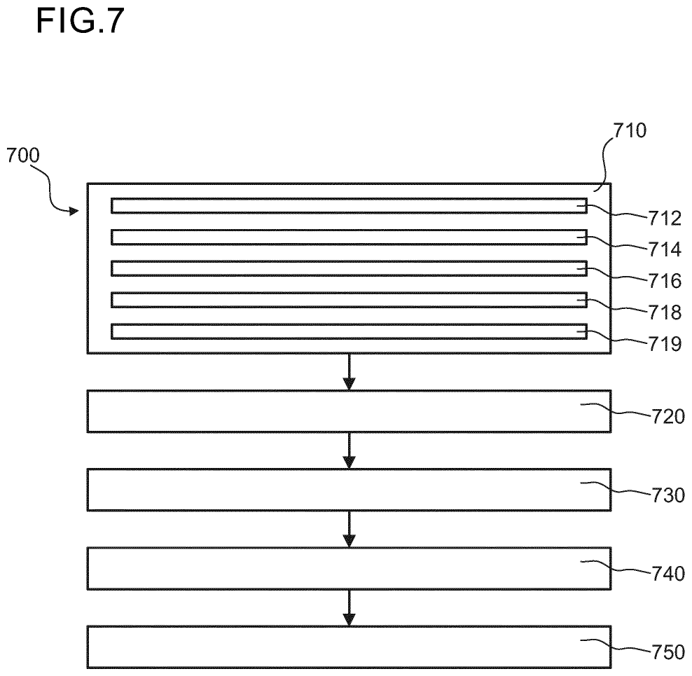

The homoscedasticity binary classifier is trained according to the embodiment of the training method 700 presented in FIG. 7.

In step 710, training sets of training homoscedasticity validation data are generated in form of 2D vectors including residual values associated to predicted values. Step 710 includes substeps 712, 714, 716, 718, and 719.

In substep 712, 19200 training sets of training homoscedasticity validation data fulfilling the homoscedasticity condition are generated, i.e., 19200 homoscedastic training sets are generated. In other embodiments, also another number of homoscedastic training sets may be generated. The homoscedastic training sets are generated by randomly sampling a range of parameters, including a number of residual values and a variance of the residual values. The residual values plotted over predicted values in the homoscedastic training sets have a randomly distributed shape.

In substeps 714, 716, 718, and 719, 19200 training sets of training homoscedasticity validation data not fulfilling the homoscedasticity condition are generated, i.e., 19200 heteroscedastic training sets are generated. In other embodiments, also another number of heteroscedastic training sets may be generated. In this embodiment, four different types of heteroscedastic training sets with 4800 heteroscedastic training sets per type are generated.

This results in a total amount of 38400 training sets of training homoscedasticity validation data, each including between 50 to 200 residual values, or observations, respectively. If a training set of the training sets of training homoscedasticity validation data does not include 200 residual values, additional zeros are added, i.e., a zero padding, such that each of them includes 200 residual values of which up to 150 may be zeros.

In substep 714, increasing variance training sets are generated, i.e., the variance of the residual values increases over the predicted values. The increasing variance training sets are generated by sampling a range of parameters, including a number of residual values, a base variance of the residual values, and a rate of variance change. The residual values plotted over predicted values in increasing variance training sets have a shape in which the variance increases over the plotted values.

In substep 716, decreasing variance training sets are generated, i.e., the variance of the residual values decreases over the predicted values. The decreasing variance training sets are generated by sampling a range of parameters, including a number of residual values, a base variance of the residual values, and a rate of variance change. The residual values plotted over predicted values in decreasing variance training sets have a shape in which the variance decreases over the plotted values.

In substep 718, convex training sets are generated, i.e., the variance of the residual values first increases and then decreases over the predicted values starting at a certain predicted value, e.g., a midpoint. The convex training sets are generated by sampling a range of parameters, including a number of residual values, a base variance of the residual values, a rate of variance change, and a midpoint. The residual values plotted over predicted values in convex training sets have a shape in which the variance of the residual values first increases and then decreases over the plotted values starting at a certain predicted value, e.g., the midpoint.

In substep 719, concave training sets are generated, i.e., the variance of the residual values first decreases and then increases over the predicted values starting at a certain predicted value, e.g., a midpoint. The concave training sets are generated by sampling a range of parameters, including a number of residual values, a base variance of the residual values, a rate of variance change, and a midpoint. The residual values plotted over predicted values in concave training sets have a shape in which the variance of the residual values first decreases and then increases over the plotted values starting at a certain predicted value, e.g., the midpoint.

In step 720, the training sets of training homoscedasticity validation data generated in step 710 are randomly assigned as training sets and testing sets. In this embodiment, 80% of the training sets of training homoscedasticity validation data are assigned as training sets and 20% are assigned as testing sets.

In step 730, the homoscedastic binary classifier 500 presented in FIG. 5 is trained based on the training sets with a learning rate of 0.003. The training is performed based on mini-batch gradient in which 512 batches are randomly selected from the training sets. The training is performed for 20 epochs. In other embodiments also between 15 and 25 epochs may be used for training.

In step 740, the homoscedasticity binary classifier is tested with the testing sets. The validation accuracy reaches 83%.

In step 750, the homoscedasticity binary classifier 500 is provided as a trained 2D CNN for further use, e.g., to validate linear models.

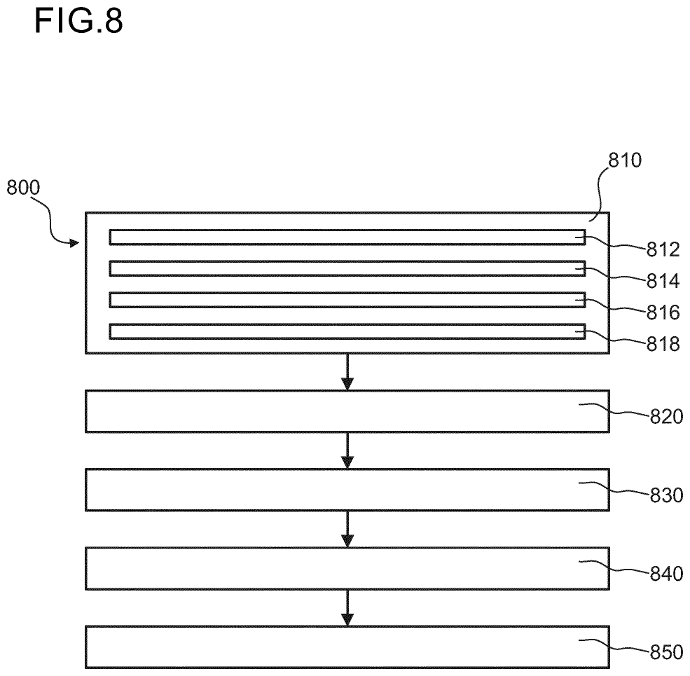

The normality binary classifier is trained according to the embodiment of the training method 800 presented in FIG. 8.

In step 810, training sets of training normality validation data are generated in form of 1D vectors including counts of residual values in predetermined residual value ranges. Step 810 includes substeps 812, 814, 816, and 818.

In substep 812, 135000 training sets of training normality validation data fulfilling the normality condition are generated, i.e., 135000 normal training sets are generated. In other embodiments, also another number of normal training sets may be generated. The normal training sets are generated by sampling normal distributions with a range of parameters including number of counts, mean, and standard deviation.

In substeps 814, 816, and 818, 135000 training sets of training normality validation data not fulfilling the normality condition are generated, i.e., 135000 non-normal training sets are generated. In other embodiments, also another number of non-normal training sets may be generated. In this embodiment, three different types of non-normal training sets with 45000 non-normal training sets per type are generated.

This results in a total amount of 270000 training sets of training normality validation data, each including between 50 to 200 counts of residual values in a predetermined residual value range, or observations, respectively. If a training set of the training sets of training normality validation data does not include 200 counts, additional zeros are added, i.e., a zero padding, such that each of them includes 200 counts of which up to 150 may be zeros.

In substep 814, skew-normal training sets are generated. The skew-normal training sets are generated by sampling skew-normal distributions with a range of parameters including counts and skew alpha. 1250 skew-normal training sets are generated for each parameter value.

In substep 816, Poisson training sets are generated. The Poisson training sets are generated by sampling Poisson distributions with a range of parameters including counts and Poisson lambda. 1250 Poisson training sets are generated for each parameter value.

In substep 818, log-normal training sets are generated. The log-normal training sets are generated by sampling log-normal distributions with a range of parameters including counts and log-normal standard deviation sigma. 1250 Poisson training sets are generated for each parameter value.

In step 820, the training sets of training normality validation data generated in step 810 are randomly assigned as training sets and testing sets. In this embodiment, 80% of the training sets of training homoscedasticity validation data are assigned as training sets and 20% are assigned as testing sets.

In step 830, the normality binary classifier 600 presented in FIG. 6 is trained based on the training sets with a learning rate of 0.001. The training is performed based on mini-batch gradient in which 512 batches are randomly selected from the training sets. The training is performed for 20 epochs. In other embodiments also between 15 and 25 epochs may be used for training.

In step 840, the normality binary classifier is tested with the testing sets. The validation accuracy reaches 84%.

In step 850, the normality binary classifier 600 is provided as a trained 1D CNN for further use, e.g., to validate linear models.

The binary classifier may also be provided as another data driven model trained based on training sets of training validation data fulfilling the validation condition and training sets of training validation data not fulfilling the validation condition, such that the binary classifier outputs that the validation condition is fulfilled or not fulfilled depending on the set of validation data which is provided as input to the binary classifier.

In step 114, it is determined by the two binary classifiers whether the sets of validation data fulfill the validation conditions, i.e., whether the homoscedasticity validation data is homoscedastic and the normality validation data is normally distributed. This allows to determine whether the linear model 300 is valid. In this embodiment, the linear model 300 is determined to be valid, if both validation conditions are fulfilled. In other embodiments, it may also be determined whether the linear model is valid based on the output of the two binary classifiers in another manner.

In other embodiments, it may also be determined whether the linear model is valid based on the output of only one binary classifier. In this case it may be determined by the binary classifier whether the set of validation data fulfills the validation condition and the linear model may be determined to be valid if the set of validation data fulfills the validation condition.

If the linear model is determined not to be valid, step 116 is performed.

If the linear model is determined to be valid, step 118 is performed.

In step 116, the linear model 300 is adapted to an adapted linear model. The processor 220 can be configured and used for adapting the linear model 300. In this embodiment, the linear model 300 may be adapted by transforming the response variable of the input data 315. In other embodiments, the input data 315 may be transformed and subsequently one or more parameters of the linear model 300 may be adapted.

After the linear model 300 is adapted to the adapted linear model, steps 106 to 114 are repeated for the adapted linear model. In other words, the steps performed for validating the linear model 300 are performed on the adapted linear model. This may be performed iteratively, until the linear model 300 or adapted linear model, respectively, is determined to be valid in step 114.

In step 118, the linear model is provided for further use. In this embodiment, the processor 220 is configured for providing the linear model 300. The processor 220 may provide the linear model 300 to the communication interface 210 which may provide it to the server 240. The validated linear model may optionally be used in step 120.

In step 120, the validated linear model is used for controlling growth of plants in the different fields. This allows improving growth of plants on different fields by checking agricultural effectiveness of different concentrations of agricultural chemicals for improving growth of the plants. In other embodiments, the linear model may also, for example, be linear models for checking effectiveness of different application of products to different fields or planting different types of plants, such as different genetically modified plants to different fields. In other embodiments, the linear model may be used for determining disease susceptibility of genetically modified soy plants. This may allow for faster decisions on which genetic modifications to further propagate and test.

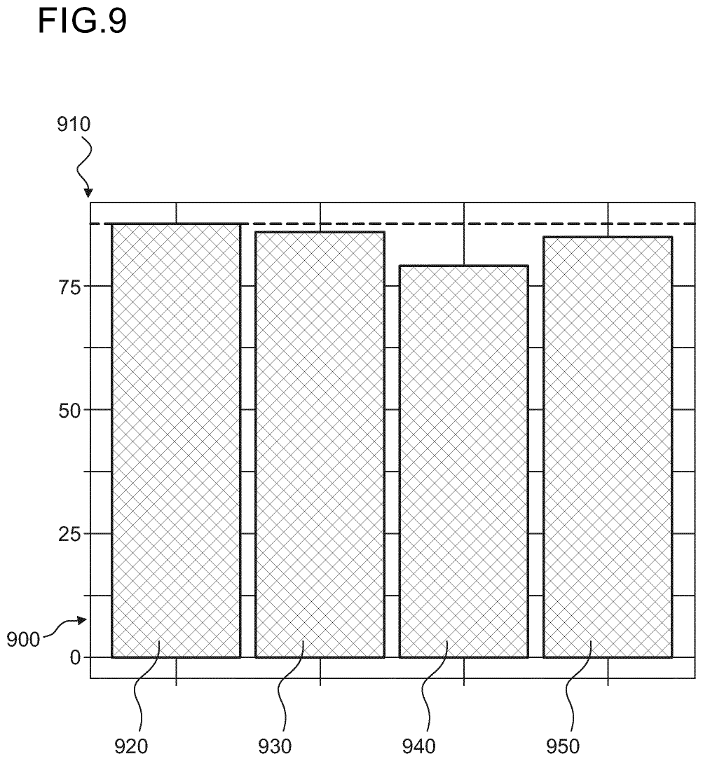

FIG. 9 shows a plot 900 comparing validation accuracy 910 of the 1D CNN 920 presented in FIG. 6 for validating the linear model with d'Agostino normality test 930, Lillefors normality test 940, and Shapiro-Wilk normality test 950. The 1D CNN 920 allows to achieve an improved validation accuracy over the statistical normality tests with 87.6% accuracy. In other words, the 1D CNN 920 correctly identifies normal distributions in 87.6% of the cases. Furthermore, a similar improvement of the validation accuracy of the 2D CNN presented in FIG. 5 over statistical homoscedasticity tests is achieved (not shown).

In the above described embodiments, the linear model was utilized in an agricultural context, in particular, to increase a plant yield. However, in other applications the linear model that is validated can be applied in completely different application contexts. For example, the linear model can be a quality or property control model configured for predicting a quality or property of a product based on process parameters of the production process. Moreover, the linear model can also be applied in product development processed in order to predict properties of at least a part of the product based on its chemical or physical characteristics. For example, the linear model can be utilized to predict an efficiency or toxicity of a drug based on the composition of the drug. In the following preferred applications for the validation of linear models are described in more detail.

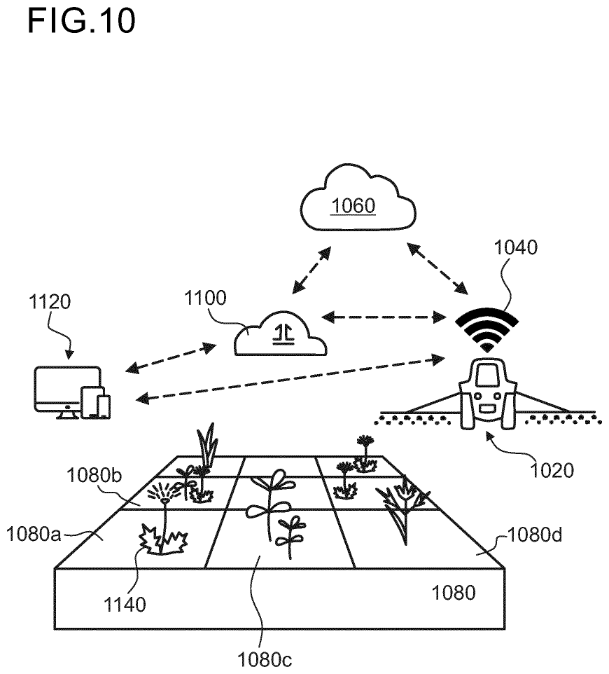

FIG. 10 illustrates a plant treatment device 1020 shown here as part of a distributed computing environment. The treatment device 1020 is used for performing and/or conducting an agricultural farming operation on a field which comprises a plurality of geographical locations 1080. The farming operation may be a treatment for a crop which comprises a crop plant 1140 located at a first geographical location 1080a. The farming operation may even relate to a control or eradication of weed plants. 1080d may refer to a second geographical location which may also include crop. 1080c may refer to a third geographical location, comprising weed. 1080b may refer to a third geographical location comprising weed and crop.

The treatment device 1020 may include a connectivity interface 1040. The connectivity interface 1040 may either be a part of a network interface, or it may be a separate unit. In this drawing for simplicity it is assumed that the connectivity interface 1040 and the network interface are the same unit. The connectivity interface 1040 is operatively coupled to a computing unit (not shown explicitly in FIG. 10). The computing unit is operatively connectable to the treatment device 1020. The connectivity interface 1040 is configured to communicatively couple the treatment device 1020 to the distributed computing environment. The connectivity interface 1040 can be configured to provide field specific data at the computing unit. Moreover, the connectivity interface 1040 can also be configured to provide update data, for example collected at the treatment device 1020 to any one or more remote computing resources 1060, 1100, 1120 of the distributed computing environment. Any one or more of the computing resources 1060, 1100, 1120 may be a remote server 1060, which can be a data management system configured to send data to the treatment device 1020 or to receive data from the treatment device 1020. For example, detected maps or as farming operation maps comprising update data recorded during the farming operation on a geographical location 1080a may be sent from the treatment device 1020 to the remote server 1060, shown in this example as a cloud based service. Any one or more of the computing resources 1060, 1100, 1120 may be a field management system 1100 that may be configured to provide a control protocol, an activation code or a decision logic, or in general field specific data, to the treatment device 1020 or to receive data, for example, update data, from the treatment device 1020. Alternatively, or in addition, such data may be received by the field management system 1100 via the remote server 1060 or data management system. Any one or more of the computing resources 1060, 1100, 1120 may be a client computer 1120 that may be configured to receive client data from the field management system 1100 and/or the treatment device 1020. Such client data may include for instance, a farming operation schedule to be conducted on one or more fields or on the plurality of geographical locations 1080 with the treatment device or field analysis data to provide insights into the health state of certain one or more geographical locations or fields. The client computer 1120 may also refer to a plurality of devices, for example a desktop computer and/or one or more mobile devices such as a smartphone and/or a tablet and/or a smart wearable device. The treatment device 1020 may be at least partially equipped with the computing unit, or the computing unit may be a mobile device that can be connected to the treatment device, via the connectivity interface 1040. It will be appreciated that the field management system 1100 and the remote server 1060 may be the same unit. The computing unit may receive the field specific data either via the client computer 1120, or it may receive it directly from the remote server 1060 or the field management system 1100.

In particular when data such as update data is recorded by the treatment device 1020 such data may be distributed to any one or more of the computing resources 106, 110, 112 of the distributed computing environment. In this example, the field management system 1100 is configured to use a linear model that can determined based on received data a treatment plan for the treatment device 1020. In particular, the linear model can be adapted to predict a plant yield based on a potential treatment plan and based on measurement data received, for instance, from the treatment device 1020, wherein a potential treatment plan is then selected based on the plant yield prediction. However, the linear model can also be utilized to directly suggest a treatment of the plants based on data received, for instance, by the treatment device 1020. In this context the field management system 1100 is preferably adapted to validate a utilized linear model using the invention, for example, as described above. The validation thus allows to ensure that the utilized linear model fulfils the predetermined conditions and thus allows for an accurate control, for instance, of the treatment device 1020.

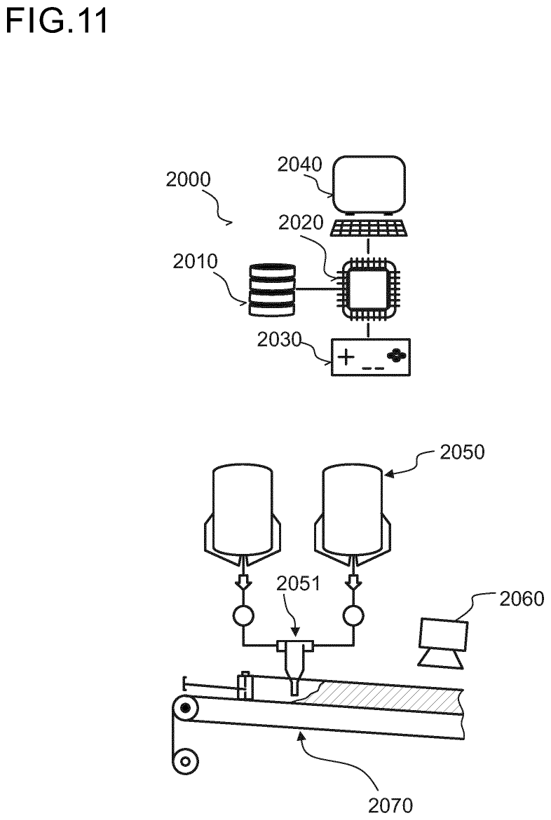

In a further preferred application of the invention the linear model is utilized in a quality control context, for example, the linear model can be used to identify a damage status of an industrial product. This will be discussed with respect to the example shown in FIG. 11. FIG. 11 shows an exemplary system 2000 for identifying a damage status of an industrial product. The system 2000 may comprise a data storage 2010, a decision-support apparatus 2020, an electronic communication device 2030, a user interface 2040, an object modifier 2050 with a treatment device 2051, and a camera 2060. The decision-support apparatus 2020 may be embodied as, or in, a workstation or server. The decision-support apparatus 2020 may provide a respective decision support as a web service e.g., to the electronic communication device 2030 or to user interface 2040. Generally the decision-support apparatus 2020 is configured for providing a quality control for a product produced, for example, in a continuous production process. In this context the decision-support apparatus 2020 can, for example, comprise an image analysing apparatus and a linear model configured to identify a damage status of the produced industrial product. The linear model can be a trained or generally be determined based on a training dataset retrieved from the data storage 2010. For example, the training database can comprise synthetic training data or measured training data that allows to derive the linear model for the quality of a produced product. During deployment of the linear model, the camera 95 can take images, for instance, from products or particles on a conveyor belt 2070. The images are provided e.g., to an image analysing apparatus (not shown in FIG. 11) in the decision-support system 2020. Using the linear model, the image analysing apparatus can be configured to detect damaged locations on the product, for example, locations where a surface of the product may show a deviation from normal (or from a standard). The object modifier 2050 may then receive the location information of the damaged location from the decision-support apparatus 2020, and trigger the treatment device 2051 to act on the damaged location of the surface. The operation of treatment device decision-support apparatus 2020 is not limited to a single specific point, its operator can apply measures to substantially all points of the object, with point-specific intensity derived from the location information. For example, as shown in FIG. 11, the system may be used to detect defective particles or products on the conveyor belt 2070. If it is detected that one or more defective particles are present at one or more points, the treatment device 2051, e.g., an air blower, can be controlled by the object modifier 2050 to remove the defective particles from the conveyor belt. Also in this application it is preferred that the decision-support apparatus 2020 is configured to validate the linear model in accordance with the invention as described above in order to ensure that the detection of the defective product locations is accurate.

Other variations to the disclosed embodiments can be understood and effected by those skilled in the art in practicing the claimed invention, from a study of the drawings, the disclosure, and the appended claims.

In the claims, the words “comprising” and “including” do not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

A computer program product may be stored/distributed on a suitable medium, such as an optical storage medium or a solid-state medium, supplied together with or as part of other hardware, but may also be distributed in other forms, such as via the Internet or other wired or wireless telecommunication systems.

Any reference signs in the claims should not be construed as limiting the scope.

The present invention relates to validating a linear model. Input data is received and the linear model to be validated is provided. Predicted data is determined based on processing input data by the linear model. Residual data is determined based on a difference between the predicted data and the input data. A set of validation data including homoscedasticity validation data or normality validation data is generated based on the residual data. A binary classifier is provided and used for determining whether the set of validation data fulfills a validation condition, namely a homoscedasticity condition or a normality condition. The binary classifier is a trained data driven model that outputs that the validation condition is fulfilled or not fulfilled depending on the set of validation data. Finally, it is determined whether the linear model is valid based on the output of the binary classifier.

1. A system for validating a linear model, the system comprising a communication interface and a processor,
wherein the communication interface is configured for receiving input data which includes response values for different explanatory values, and
wherein the processor is configured for validating the linear model by performing the steps:
determining predicted data based on processing the input data by the linear model, wherein the predicted data includes predicted values for the different explanatory values,
determining residual data based on a difference between the predicted data and the input data, wherein the residual data includes residual values for the different explanatory values determined based on the difference between the response values and their corresponding predicted values,
generating a set of validation data based on the residual data, wherein the set of validation data includes homoscedasticity validation data or normality validation data,
providing a binary classifier for determining whether the set of validation data fulfills a validation condition, wherein the validation condition is a homoscedasticity condition if the set of validation data includes homoscedasticity validation data or a normality condition if the set of validation data includes normality validation data, and wherein the binary classifier is a data driven model trained based on training sets of training validation data fulfilling the validation condition and training sets of training validation data not fulfilling the validation condition, such that the binary classifier outputs that the validation condition is fulfilled or not fulfilled depending on the set of validation data which is provided as input to the binary classifier,
determining by the binary classifier whether the set of validation data fulfills the validation condition, and
determining whether the linear model is valid based on the output of the binary classifier.

2. The system according to claim 1, wherein the processor is further configured for providing the linear model, if the linear model is determined to be valid.

3. The system according to claim 1, wherein the processor is further configured for adapting the linear model to an adapted linear model and for performing the steps performed for validating the linear model on the adapted linear model.

4. The system according to claim 3, wherein the processor is configured for adapting the linear model based on transforming the input data.

5. The system according to claim 3, wherein the processor is further configured for iteratively adapting the linear model until the adapted linear model is determined to be valid.

6. The system according to claim 1, wherein the response values are measured plant yield values and the different explanatory values relate to different fields on which the plants grow.

7. The system according to claim 6, wherein the system is configured for controlling a growth of the plants in the different fields based on the linear model, if the linear model is determined to be valid.

8. The system according to claim 1, wherein the processor is configured for generating at least two different sets of validation data based on the residual data and for providing at least two binary classifiers each configured for determining whether the respective set of validation data fulfills a respective validation condition and wherein the processor is configured for determining whether the linear model is valid based on the output of the at least two binary classifiers.

9. The system according to claim 1, wherein the binary classifier is a trained convolutional neural network.

10. The system according to claim 9, wherein the convolutional neural network has at least 4 convolutional layers.

11. The system according to claim 9, wherein the convolutional neural network has the following architecture:
a first convolutional layer,
a first max pooling layer,
a second convolutional layer,
a third convolutional layer,
a second max pooling layer,
a dropout layer,
a fourth convolutional layer,
a global max pooling layer,
a first densely-connected layer, and
a second densely-connected layer.

12. A computer implemented method for validating a linear model, comprising:
receiving input data which includes response values for different explanatory values, and
validating the linear model by performing the steps:
determining predicted data based on processing the input data by the linear model, wherein the predicted data includes predicted values for the different explanatory values,
determining residual data based on a difference between the predicted data and the input data, wherein the residual data includes residual values for the different explanatory values determined based on the difference between the response values and their corresponding predicted values,
generating a set of validation data based on the residual data, wherein the set of validation data includes homoscedasticity validation data or normality validation data,
providing a binary classifier for determining whether the set of validation data fulfills a validation condition, wherein the validation condition is a homoscedasticity condition if the set of validation data includes homoscedasticity validation data or a normality condition if the set of validation data includes normality validation data, and wherein the binary classifier is a data driven model trained based on training sets of training validation data fulfilling the validation condition and training sets of training validation data not fulfilling the validation condition, such that the binary classifier outputs that the validation condition is fulfilled or not fulfilled depending on the set of validation data which is provided as input to the binary classifier,
determining by the binary classifier whether the set of validation data fulfils the validation condition, and
determining whether the linear model is valid based on the output of the binary classifier.

13. The computer implemented method according to claim 12, including one or more of the steps:
providing the linear model, if the linear model is determined to be valid,
adapting the linear model to an adapted linear model,
performing the steps performed for validating the linear model on the adapted linear model,
adapting the linear model based on transforming the input data,
iteratively adapting the linear model until the adapted linear model is determined to be valid,
measuring plant yield values as response values related to different fields on which the plants grow as explanatory values,
controlling growth of the plants in the different fields based on the linear model, if the linear model is determined to be valid,
generating at least two different sets of validation data based on the residual data,
providing at least two binary classifiers each configured for determining whether the respective set of validation data fulfills a respective validation condition,
determining whether the linear model is valid based on the output of the at least two binary classifiers,
providing the binary classifier as a convolutional neural network,
providing that the convolutional neural network has at least 4 convolutional layers,
providing that the convolutional neural network has the following architectures:
a first convolutional layer,
a first max pooling layer,
a second convolutional layer,
a third convolutional layer,
a second max pooling layer,
a dropout layer,
a fourth convolutional layer,
a global max pooling layer,
a first densely-connected layer, and
a second densely-connected layer, and
training the binary classifier based on training sets of training validation data fulfilling the validation condition and training sets of training validation data not fulfilling the validation condition, such that the binary classifier outputs that the validation condition is fulfilled or not fulfilled depending on the set of validation data which is provided as input to the binary classifier.

14. A computer program product for validating a linear model, wherein the computer program product comprises program code means for causing a processor to carry out the computer-implemented method according to claim 12, when the computer program product is run on the processor.

15. The computer readable medium having stored the computer program product of claim 14.
